(19) United States
(12) Patent Application Publication
(10) Pub. No.: US 2014/0325160 A1
(43) Pub. Date: Oct. 30, 2014

(54) CACHING CIRCUIT WITH PREDETERMINED HASH TABLE ARRANGEMENT

(71) Applicant: HEWLETT-PACKARD DEVELOPMENT COMPANY, L.P., Houston, TX (US)

(72) Inventors: Kevin T. Lim, La Honda, CA (US); Sai Rahul Chalamalasetti, Houston, TX (US); Jichuan Chang, Sunnyvale, CA (US); Mitchel E. Wright, The Woodlands, TX (US)

(73) Assignee: Hewlett-Packard Development Company, L.P., Houston, TX (US)

(21) Appl. No.: 13/873,459

(22) Filed: Apr. 30, 2013

(51) Int. Cl. G06F 12/12; G06F 12/08

(52) U.S. Cl. CPC G06F 12/122; G06F 12/0871
USPC 711/136

(57) ABSTRACT

Disclosed herein are an apparatus, an integrated circuit, and method to cache objects. At least one hash table of a circuit comprises a predetermined arrangement that maximizes cache memory space and minimizes a number of cache memory transactions. The circuit handles requests by a remote device to obtain or cache an object.

### BACKGROUND

“Memcached” is a cache system used by web service providers to expedite data retrieval and reduce database workload. A Memcached server may be situated between a front-end web server (e.g., Apache) and a back-end data store (e.g., SQL databases). Such a server may provide caching of content or queries from the data store thereby reducing the need to access the back-end.

### BRIEF DESCRIPTION OF THE DRAWINGS

FIG. 1 is a block diagram of an example circuit in accordance with aspects of the present disclosure.

FIG. 2 is a flow diagram of an example method in accordance with aspects of the present disclosure.

FIG. 3 is an example hash table arrangement in accordance with aspects of the present disclosure.

FIG. 4 is a further example hash table arrangement in accordance with aspects of the present disclosure.

FIG. 5 is yet a further example hash table arrangement in accordance with aspects of the present disclosure.

### DETAILED DESCRIPTION

As noted above, web service providers may utilize Memcached to reduce database workload. In a Memcached system, objects may be cached across multiple machines with a distributed system of hash tables. When a hash table is full, subsequent inserts may cause older cached objects to be purged in least recently used (“LRU”) order. Memcached servers primarily handle network requests, perform hash table lookups, and access data. However, stress tests have shown that Memcached servers spend most of their time engaging in activity other than core Memcached functions. For example, one test shows that Memcached servers spend a considerable amount of time on network processing. Moreover, multiple web applications may generate millions of requests for cached objects; stress tests show that Memcached servers may also spend a significant amount of time handling and keeping track of these requests.

In addition to performance bottlenecks, tests show that power consumption may also be a concern for conventional Memcached servers. For example, a study shows that a Memcached server with two Intel Xeon central processing units (“CPUs”) and 64 Gigabytes of DRAM consumes 258 Watts of total power. 190 Watts of the total power was distributed between the two CPUs in the system; 64 Watts were consumed by DRAM memory; and, 8 Watts were consumed by a 1 GbE Ethernet network interface card. Thus, this study confirms that the CPU may consume a disproportionate amount of power.

In view of the foregoing, disclosed herein are an apparatus, integrated circuit, and method for caching objects. In one example, at least one hash table of a circuit comprises a predetermined arrangement that maximizes cache memory space and minimizes a number of cache memory transactions. In a further example, the circuit handles requests by a remote device to obtain or cache an object. By integrating the networking, processing, and memory aspects of Memcached systems, more time may be spent on core Memcached functions. Thus, the techniques disclosed herein alleviate the bottlenecks of conventional Memcached systems. The aspects, features and other advantages of the present disclosure will be appreciated when considered with reference to the following description of examples and accompanying figures. The following description does not limit the application; rather, the scope of the disclosure is defined by the appended claims and equivalents.

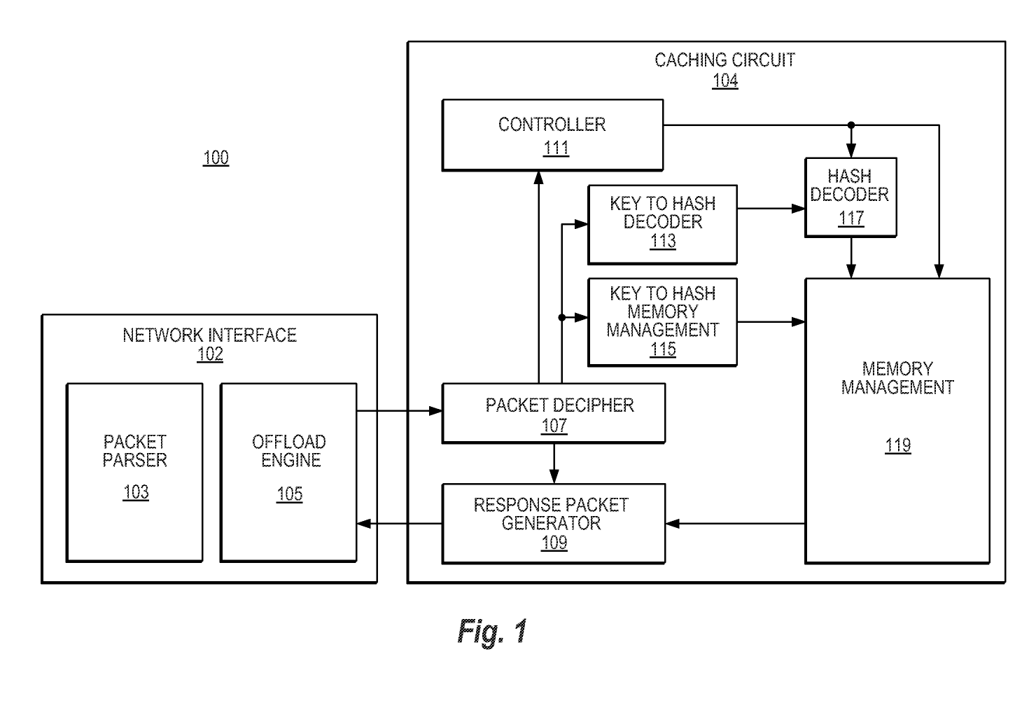

FIG. 1 presents a schematic diagram of an illustrative circuit 100 for executing the techniques disclosed herein. The circuit 100 may be an application specific integrated circuit (“ASIC”), a programmable logic device (“PLD”), or a field programmable gate array (“FPGA”). Thus, circuit 100 may be customized to communicate with remote devices over a network and to cache objects and retrieve cached objects. Circuit 100 may include components that may be used in connection with Memcached functions and networking. In one example, circuit 100 may be implemented on an Altera Terasic DED-4 board. Circuit 100 may have a caching circuit 104 and a network interface 102. Network interface 102 may comprise a packet parser 103 to parse incoming packets received from a remote device. A packet may include an object and a command to cache the object (“set command”). Alternatively, the packet may include a request to retrieve an already cached object (“get command”). In one implementation, network interface 102 may use an Ethernet interface, such as an Altera Triple Speed Ethernet (“TSE”) MAC, to communicate with remote devices over a network. Offload engine 105 may detect packets intended for caching circuit 104 and transmit the packets thereto. Offload engine 105 may also be used to generate a response from caching circuit 104 with a requested cached object therein. In one example, offload engine 105 may extract packet header and user data information from a packet; determine whether the received packet is a set or get command intended for caching circuit 104; and, place the packet in a queue from which each packet may be processed in first-in-first-out (“FIFO”) order. Such a queue may ensure that continuous requests from multiple clients will not be discarded while a prior command is being processed.

Caching circuit 104 may include a packet decipher engine 107 to determine whether a packet is a get command or set command. Packet decipher engine 107 may analyze the received packets and may store respective field information for further command processing. Irrespective of whether a packet is a set or get command, a packet may comprise a header field, which may include data such as an operation code, a key length, and a total data length. After the header field, the packet format may vary depending on the type of operation. For example, a set command may comprise an object to be cached in the hash table, user data, and a key. In a similar manner, a get command may comprise a basic header field, and a key to determine the location of the cached object. The key may be generated by the client requesting the set or get command, and the key may be a string that is somehow associated with the cached object. For example, if a phone number of a person named “John” is the cached object, “John” may be the key and hash(“John”) may represent the hash table address where the key “John” and its associated phone number will be stored (i.e. the key-value pair). In another example, the key may be a database query and the cached object may be the data returned by the query.

Key to hash memory management module 115 may be comprise a data path for objects being cached. Memory management module 119 may comprise a collection of functional units that perform caching of objects. Memory management module 119 may further comprise a dynamic random access memory (“DRAM”) module divided into two sections: hash memory and slab memory. The slab memory may be used to allocate memory suitable for objects of a certain type or size. Memory management module 119 may keep track of these memory allocations such that a request to cache a data object of a certain type and size can instantly be met with a pre-allocated memory location. In another example, destruction of an object makes a memory location available and may be put on a list of free slots by memory management module 119. Thus, a set command requiring memory of the same size may return the now unused memory slot. Accordingly, the need to search for suitable memory space may be eliminated and memory fragmentation may be alleviated.

Key to hash decoder module 113 may comprise a data path for objects to be hashed and hash decoder 117 may generate a hash for an incoming key associated with an object to be cached. In one implementation, hash decoder 117 may accept three inputs; each input may be a 4 byte segment of the key among three internal variables (e.g., a, b and c). Initially, the hash algorithm may accumulate the first set of 12 byte key segments with a constant, so that the mix module has an initial state. After the combine state is processed, the input variables may be passed to the mix state. At this point, a counter, which may be called length_of_key, may be decremented by 12 bytes in each iteration of combine and mix module execution. After each iteration, hash decoder 117 may determine whether the length_of_key counter is greater than 12 bytes. If the remaining length is less than or equal to 12 bytes, the intermediate key may be routed to a final addition block, which may execute the combine functionality for key lengths less than or equal to 12 bytes. Hash decoder 117 may then compute the internal illustrative variables a, b and c with a final addition/combine block. Hash decoder 117 may then pass the variables to a final mix data path to post process the internal states so that it can generate the final constant hash value.

Controller 111 may comprise control logic to perform a set or get command by coordinating activities between hash decoder 117 and memory management module 119. Controller 111 may instruct hash decoder 117 to perform a hash on a key to determine the hash table address. Once hash decoder 117 signals controller 111 that it has completed execution of a hash function, controller 111 may then signal memory management module 119 to perform a get or set command. For example, during a get command, once the hash value is ready, memory management module 119 may look up the hash table address. Once the value is retrieved, controller 111 may place the data on a FIFO queue in preparation for response packet generator 109. If the data is not found in the hash bucket, controller 111 may instruct response packet generator 109 to generate a miss response. When a set command is received, hash decoder 117 may perform a hash of the key to determine the hash table location of the new key-value pair and memory management module 119 may cache the object into the corresponding entry. Once completed, controller 111 may instruct response packet generator 109 to reply to the client with a completion message.

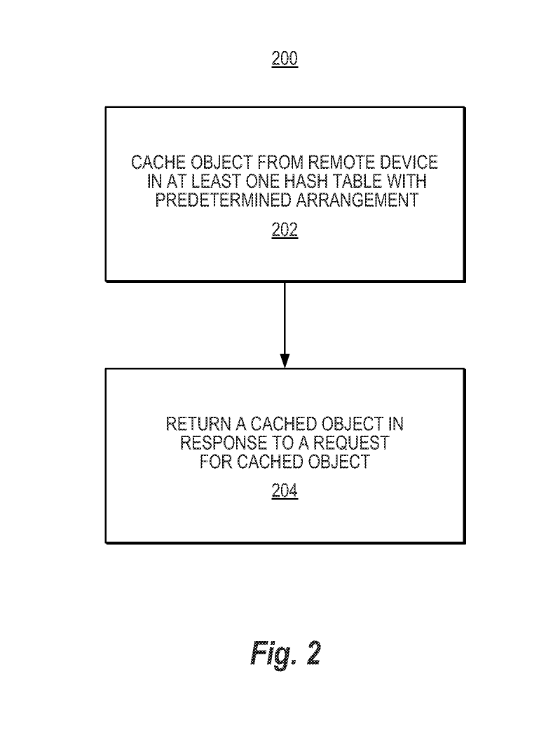

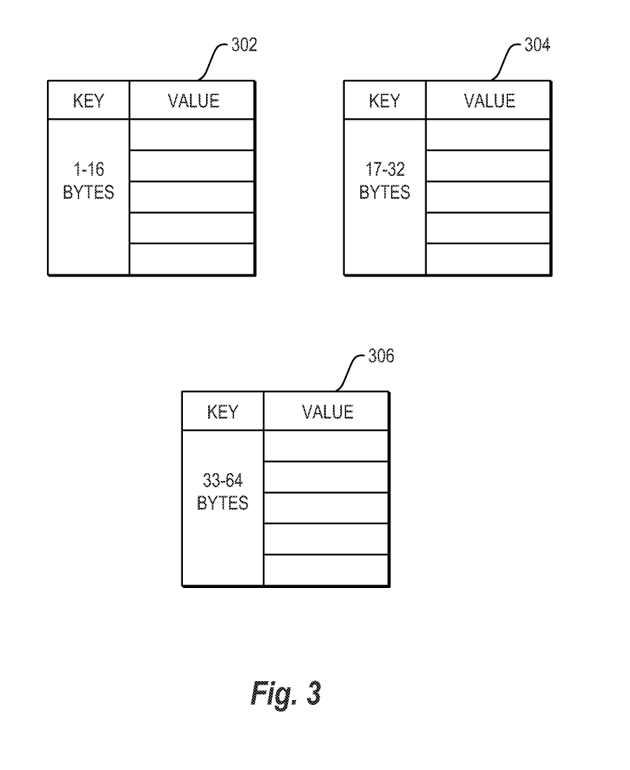

Working examples of the apparatus, integrated circuit, and method are shown in FIGS. 2-4. In particular, FIG. 2 illustrates a flow diagram of an example method 200 for handling Memcached commands. FIGS. 3-5 each show an example in accordance with the techniques disclosed herein. The actions shown in FIGS. 3-5 will be discussed below with regard to the flow diagram of FIG. 2.

As shown in block 202 of FIG. 2, an object received from a remote device may be cached in at least one hash table. The at least one hash table may have a predetermined arrangement that maximizes cache memory space and minimizes a number of cache memory transactions. As such, the hash table(s) may be designed in a variety of ways. In one example, multiple hash tables may be utilized and each hash table may store a range of key sizes within a larger predetermined range. The larger predetermined range may be based on an expected range. In turn, the expected range may be based on an analysis of the keys contained in prior set and get commands. Referring now to FIG. 3, three illustrative hash tables are shown. In this example, the predetermined range is 1 through 64 bytes. The hash tables 302, 304, and 306 may be stored in DRAM of memory management module 119. Table 302 has a range of 1-16 byte keys; table 304 has a range of 17-32 byte keys; and, table 306 has a range of 33-64 byte keys. The value columns of each table may contain the value associated with each key or a pointer to the value. Arranging the hash tables based on a predetermined range of key sizes reduces the number of cache allocations and de-allocations, since the tables are already allocated.

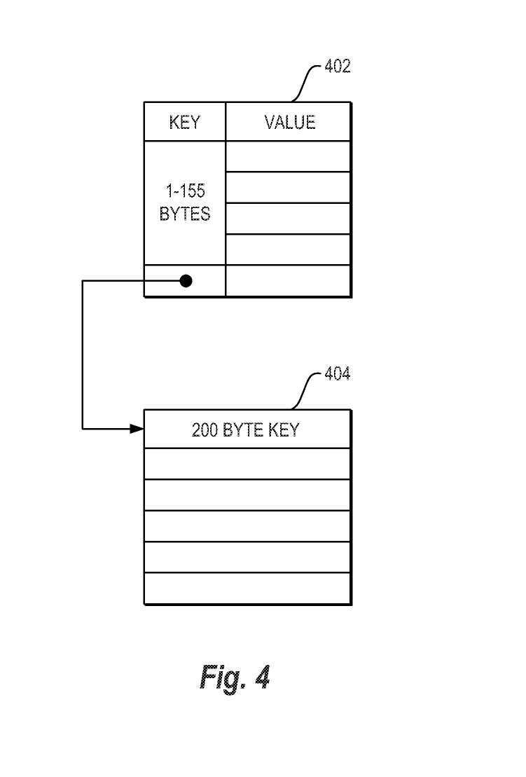

Referring now to FIG. 4, an alternate example hash table arrangement is shown. In this example, one hash table 402 is used with a predetermined range of key sizes, which may also be based on an expected range after analyzing prior set and get commands. Furthermore, this example has a predetermined range of key sizes ranging from 1 to 155 bytes. As with the hash tables of FIG. 3, the value column of hash table 402 may contain the value associated with each key or a pointer to the value associated with each key. If controller 111 determines that a given key is outside the predetermined range of key sizes, controller 111 may instruct memory management module 119 to store the given key in memory pool 404 and store a memory pool address of the given key in hash table 402. The arrangement shown in FIG. 4 allows some flexibility in the event of a deviant key size. While the allocation of space in memory pool 404 does require extra cache memory transactions, such transactions should be kept to a minimum, if the predetermined range is set correctly. In yet a further example, if a sum of the key size and the value size is within the predetermined range, then both the key and the value may be stored in the key column in order to enhance the get command. In this instance, a bit in the key-value pair may be set to indicate that the pair is stored in the key column.

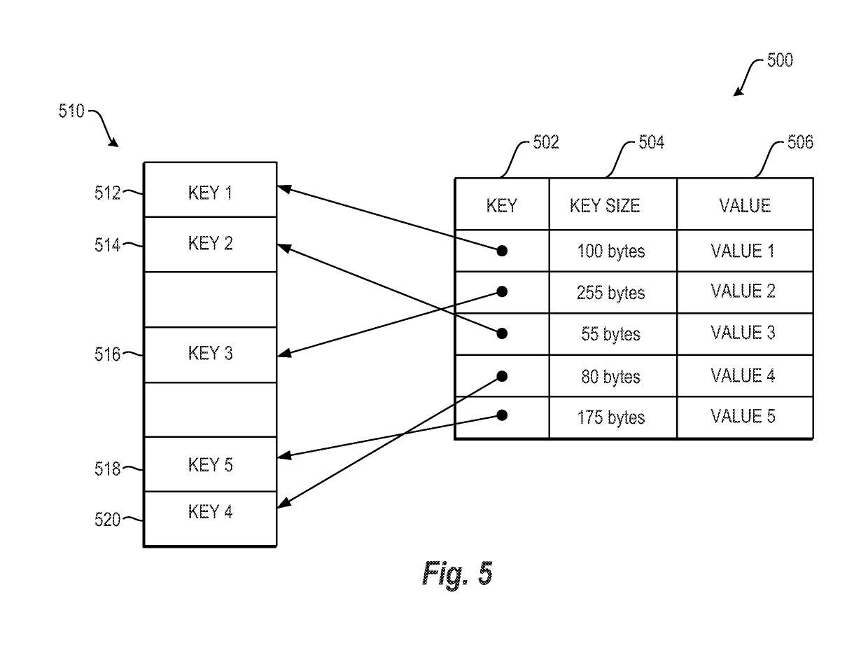

Referring now to FIG. 5, a third alternate example hash table arrangement is shown. Here, one hash table 500 may store a pointer or location of a given key in field 502. Each pointer may be associated with a location in cache memory 510. Once again, as with the hash tables discussed with reference to FIGS. 3-4, the value column 506 of hash table 500 may contain the value associated with each key or a pointer to the value associated with each key. In addition, the size of the key may be stored in field 504 and the value may be stored in field 506. In a further example, a portion of the given key may be cached in table 500; in yet a further example, a hash of the given key may be cached in table 500.

As noted above, circuit 100 may be an ASIC, a PLD, or a FPGA. As such, the different example hash tables shown in FIGS. 3-5 may be preconfigured. If an FPGA or PLD is employed, the circuit may be reconfigured if the key size ranges seem to change such that the current hash table arrangement is no longer efficient.

Referring back to FIG. 2, a cached object may be returned in response to a request for a cached object, as shown in block 204. As noted above, controller 111 may obtain an object from memory management module 119 and return the object in a packet generated by response packet generator 109. The key received for the client may be hashed to determine the location of the object. Advantageously, the foregoing apparatus, integrated circuit, and method allow a Memcached system to be implemented without the bottlenecks of conventional systems. In this regard, the integration of caching and network processing may cause web application users to experience enhanced performance. In turn, web service providers can provide better service to their customers. Furthermore, since the circuit disclosed herein employs control logic in lieu of processors, web service providers may conserve more energy than with conventional Memcached servers.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. An apparatus comprising:
a memory caching circuit to cache objects that are frequently sought after by a server, the objects being cached in at least one hash table, the at least one hash table having a predetermined arrangement that maximizes cache memory space and minimizes a number of cache memory transactions; and
a network interface to establish communication between the memory caching circuit and a network, the communication permitting the memory caching circuit to receive an object from a remote device for caching and to transmit a cached object to a remote device requesting the cached object.

2. The apparatus of claim 1, wherein each hash table in the memory caching circuit is a data structure to store a range of key sizes within a larger predetermined range of key sizes.

3. The apparatus of claim 1, wherein a hash table in the memory caching circuit comprises a predetermined range of key sizes based on an expected range of key sizes.

4. The apparatus of claim 3, wherein the memory caching circuit further to:
determine whether a size of a given key is outside the predetermined range of key sizes; and
If it is determined that the given key is outside the predetermined range, store the given key in a memory pool and store a memory pool address of the given key in the hash table.

5. The apparatus of claim 1, wherein a hash table in the memory caching circuit is a data structure to store a location of a given key stored in a cache memory and a size of the given key.

6. The apparatus of claim 5, wherein the hash table in the memory caching circuit further to store a portion of the given key or a hash associated with the given key.

7. An integrated circuit comprising:
a cache memory to cache frequently requested objects in at least one hash table, the at least one hash table comprising a predetermined arrangement so as to maximize cache memory space and minimize a number of cache memory transactions; and
a network interface to forward a cached object from the cache memory to a remote device requesting the cached object and to receive an object to be cached in the at least one hash table from a remote device.

8. The integrated circuit of claim 7, wherein each hash table is a data structure to store a range of key sizes within a larger predetermined range of key sizes.

9. The integrated of claim 7, wherein a hash table comprises a predetermined range of key sizes based on an expected range of key sizes.

10. The integrated circuit of claim 9, further comprising control logic:
determine whether a size of a given key is outside the predetermined range of key sizes; and
If it is determined that the given key is outside the predetermined range, store the given key in a memory pool and store a memory pool address of the given key in the hash table.

11. The integrated circuit of claim 7, wherein a hash table is a data structure to store a location of a given key stored in the cache memory and a size of the given key.

12. The integrated circuit of claim 11, wherein the hash table further to store a portion of the given key or a hash associated with the given key.

13. A method comprising, reading, using control logic, a request from a remote device to cache an object;
caching, using control logic, the object in a hash table of an integrated circuit, the hash table having a predetermined arrangement such that cache memory space is maximized and a number of cache memory transactions is minimized;
reading, using control logic, a request from a remote device to obtain a cached object; and
retrieving, using control logic, the cached object from the hash table in response to the request for the cached object.

14. The method of claim 13, wherein the integrated circuit comprises a plurality of hash tables such that each hash table stores a range of key sizes within a larger predetermined range of key sizes.

15. The method of claim 13, wherein the hash table comprises a predetermined range of key sizes based on an expected range of key sizes.

16. The method of claim 15, further comprising,
determining, using control logic, whether a size of a given key is outside the predetermined range of key sizes;
If it is determined that the given key is outside the predetermined range:
caching, using control logic, the given key in a memory pool; and
caching, using control logic, a memory pool address of the given key in the hash table.

17. The method of claim 13, wherein the hash table is a data structure to store a location of a given key stored in the cache memory and a size of the given key.

18. The method of claim 17, wherein the hash table further to store a portion of the given key or a hash associated with the given key.
